(19) United States
(12) Patent Application Publication
(10) Pub. No.: US 2005/0147769 A1
(43) Pub. Date: Jul. 7, 2005

(54) Porous type inkjet recording sheet and forming method of the same

(75) Inventor: Masayuki Ushiku, Yokohama-shi (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Holdings, Inc.

(21) Appl. No.: 11/019,903

(22) Filed: Dec. 22, 2004

(30) Foreign Application Priority Data
Jan. 7, 2004 (JP) JP2004-001937

(51) Int. Cl. B41M 5/40

(52) U.S. Cl. 428/32.34

(57) ABSTRACT

A porous type inkjet recording sheet comprising a substrate provided thereon an ink absorptive layer which is formed by coating a coating solution on the substrate and the drying, wherein the coating solution comprises inorganic fine particles, a hydrophilic binder and a solvent of not less than 0.8% in volume, the solvent having a boiling point of more than 100° C. and a surface tension of 30 to 40 mN/m.

### RELATED APPLICATION

This application is based on patent application No. 2004-001937 filed in Japan, the entire content of which is hereby incorporated by reference.

### BACKGROUND

1. Field of the Invention

The present invention relates to a porous type inkjet recording sheet, which is provided with a high ink absorptive property and can provide high quality images exhibiting a high glossiness and reduced bronzing generation, as well as to a manufacturing method thereof.

2. Description of the Related Art

In recent years, inkjet recording has been rapidly improving the image quality, which is approaching to photographic image quality. However, improvement of techniques for an inkjet recording sheet is desired, with respect to final print quality and image preservability.

An example of inkjet recording sheets to achieve such high image quality is an inkjet recording sheet provided with a swelling type ink absorptive layer comprising primarily a hydrophilic binder on a support, and such an inkjet recording sheet provides appearances similar to photography after recording. On the other hand high speed recording of inkjet recording method is in progress so that a high ink absorptive property and a rapid drying property are required, while an inkjet recording sheet provided with the swelling type ink absorptive layer described above is slow in an ink absorption rate and liable to generate image defects, in which images show mottled appearance due to such as association of ink liquid drops each other, in case of high speed recording. Further, there is a disadvantage of easy spreading of ink in a formed image after printing, particularly in case of being stored under high humidity.

To overcome a problem such as described above, there is known an inkjet recording sheet in which an ink absorptive rate and spreading resistance have been improved by providing an ink absorptive layer comprising a porous void layer constituted of primarily a small amount of a hydrophilic binder, a plenty amount of inorganic fine particles, a cross-linking agent and a cationic dye fixing agent. Inorganic fine particles utilized in this porous type inkjet recording sheet include those having an average particle size of approximately 1 μm and those having an average particle size of not more than 100 nm.

An inkjet recording sheet utilizing inorganic fine particles of approximately 1 μm exhibits an excellent ink absorptive property, however, the smoothness of the ink absorptive layer surface is inferior and glossiness is low. While, in the case of utilizing inorganic fine particles having an average particle size of not more than 100 nm, obtained can be an inkjet recording sheet provided with high smoothness of an ink absorptive layer surface, high glossiness and appearances similar to photography in addition to an excellent ink absorptive property.

On the other hand, an inkjet recording method, in accordance with realizing higher image quality, has come to be utilized for a proof output purpose as an application form. Since a proof purpose is for plate making inspection, it requires high print densities to obtain a high precision image having high color reproducibility in addition to image stability after printing, in particular, in relatively a short period of time. As an inkjet recording sheet for a proof output purpose, the porous type inkjet recording sheet described above is provided with high color reproducibility, which is preferable in that point, and specifically, an inkjet recording sheet provided with a high void ratio, employing inorganic fine particles of as minute as not more than 100 nm in size, is preferably utilized with respect to printing densities.

As an example of such a porous type inkjet recording sheet, for example in JP-A Nos. 10-119423 and 2000-218927 (hereinafter, JP-A refers to Japanese Patent Publication Open to Public Inspection), described is an example of a coating solution comprising silica as inorganic fine particles, polyvinyl alcohol as a hydrophilic binder and boric acid or a salt thereof as a cross-linking agent, which is provided with a viscosity increasing effect under lower temperatures. By utilizing this characteristic of a coating solution, after a coating solution is coated on a support and subjected to viscosity increasement by cooling, drying by blowing a strong wind of a relatively high temperature (approximately 20-60° C.) can be performed, and an excellent printing densities can be obtained due to the resulting ink absorptive layer provided with a high void volume.

On the other hand, in a porous type inkjet recording sheet provided with the above constitution, a printed image having a certain glossy feeling could be obtained. However, it was insufficient in comparison to silver salt photography with respect to glossiness, and there was a problem of inducing generation of bronzing. There is known a means to increase smoothness by such as a calendar treatment to obtain a higher glossiness, however, the formed void structure is destroyed, when a calendar treatment is applied so as to achieve sufficient glossiness, resulting in decrease of ink absorbability. Therefore, development of an improvement means is urgently required.

### SUMMARY

An objective of this invention is to provide a porous type inkjet recording sheet which is provided with high ink absorbability and can provide a high quality image exhibiting restrained generation of bronzing and high glossiness, as well as a manufacturing method thereof.

These objectives have been achieved by the following. (1) A porous type inkjet recording sheet comprising a substrate provided thereon an ink absorptive layer which is formed by coating a coating solution on the substrate and then drying,
wherein the coating solution comprises inorganic fine particles, a hydrophilic binder and a solvent of not less than 0.8% in volume, the solvent having a boiling point of more than 100° C. and a surface tension of 30 to 40 mN/m. (2) A porous type inkjet recording sheet comprising a substrate provided thereon an ink absorptive layer which is formed by coating a coating solution on the substrate and then drying,
wherein the coating solution comprises inorganic fine particles, a hydrophilic binder and a solvent of not less than 0.3. % in volume, the solvent having a boiling point of more than 100° C. and a surface tension of less than 30 mN/m. (3) A porous type inkjet recording sheet comprising a substrate provided thereon an ink absorptive layer,
wherein the ink absorptive layer comprises inorganic fine particles, a hydrophilic binder and a solvent of not less than 1.2 g/m², the solvent having a boiling point of more than 100° C. and a surface tension of 30 to 40 mN/m. (4) A porous type inkjet recording sheet comprising a substrate provided thereon an ink absorptive layer,
wherein the ink absorptive layer comprises inorganic fine particles, a hydrophilic binder and a solvent of not less than 0.4 g/m2, the solvent having a boiling point of more than 100° C. and a surface tension of less than 30 mN/m. (5) The porous type inkjet recording sheet in any one of the above (1) to (4),
wherein a viscosity at 40° C. of the coating solution is 10 to 300 mPa·s and the drying is carried out after a viscosity of the ink absorptive layer coated by the coating becomes not less than 40 times of the viscosity at 40° C. of the coating solution.

The invention itself, together with further objects and attendant advantages, will best be understood by reference to the following detailed description taken in conjunction with the accompanying derawings.

### DESCRIPTION OF THE PREFERRED EMBODIMENT

In the following, the best embodiment to perform this invention will be detailed.

The inventors, as a result of extensive studies to realize improvement of glossiness miscible with high ink absorbability in view of the above problems, have found that it can be achieved by a porous type inkjet recording sheet, containing at least inorganic fine particles, a hydrophilic binder and not less than 1.2 g/m² of a solvent provided with a boiling point of over 100° C. and a surface tension of 30-40 mN/m or by containing at least inorganic fine particles, a hydrophilic binder and not less than 0.4 g/m² of a solvent provided with a boiling point of over 100° C. and a surface tension of less than 30 mN/m, and that bronzing is restrained, which resulted in this invention.

The reason why addition of a specific amount of a solvent provided with a surface tension defined in this invention is effective for improvement of glossiness and depression of bronzing is not clearly understood for the moment, however, it is estimated as follows.

One of the factors to achieve the surface smoothness of an ink absorptive layer is considered that an ink absorptive layer is preferably dried in a smoothened state due to leveling of the layer in wet state after having been coated. In a constitution of this invention, it is estimated that as a result of lowering of a dynamic surface tension of a coating solution by addition of a suitable amount of a solvent provided with a low surface tension according to this invention, the leveling rate described above is increased resulting in improvement of glossiness. Further, drying by blowing a strong wind after a coating solution having been coated on a support followed by the viscosity being increased, can prevent setting mottle or solution inclination due to a drying wind, which enables a fast drying rate resulting in a high productivity. However, it has been proved as a result of this inventor's study that glossiness is hardly obtained when drying is performed after a viscosity of a coating solution has been increased to not less than 300 mP·s, and glossiness is further hardly obtained in the case of coating at a wet layer thickness of not more than 150 μm. This phenomenon is considered to be caused by drying in a state of insufficient leveling in the case that the viscosity of a coating solution has been increased. It has been proved that high glossiness can be obtained by addition of a solvent provided with a surface tension of this invention, even in the case that the viscosity of a coating solution is increased. Further, bronzing referred in this invention is a phenomenon cased by precipitation of a dye on the surface of an image recording layer and the print surface provides a image-wise metallic state resulting in significant deterioration of the print quality. This phenomenon is particularly liable to be caused when an ink absorptive rate is slow or when a cationic polymer or a polyvalent metal salt as a dye fixing agent is utilized. With respect to the above problem, an effect for depression of bronzing by addition of a solvent according to this invention having a surface tension of not more than 40 mN/m and preferably not more than 30 mN/m is considered to attributable to that a dye association is restrained due to a dispersant-like function of a solvent having a low surface tension.

In the following, this invention will be detailed.

A porous type inkjet recording sheet (herinafter, also simply referred to as a recording sheet) of this invention is characterized by containing not less than 1.2 g/m² of a solvent having a boiling point of more than 100° C. and a surface tension of 30 to 40 mN/m, or not less than 0.4 g/m² of a solvent having a boiling point of more than 100° C. and a surface tension of less than 30 mN/m, preferably containing 1.2 to 5.0 g/m² and more preferably 1.2 to 2.0 g/m², of a solvent having a surface tension of 30 to 40 mN/m, or 0.4 to 3.0 g/m² and more preferably 0.4 to 1.5 g/m², of a solvent having a boiling point of more than 100° C. and a surface tension of less than 30 mN/m.

Herein, the content of a solvent of this invention in a recording sheet can be measured by solvent extraction from a recording sheet with such as water, chloroform and methanol and by means of a variety of instrumental analysis (such as 13C-NMR, gas chromatography, liquid chromatography).

Further, in a recording sheet of this invention, a coating solution constituting an ink absorptive layer is characterized by containing not less than 0.8% in volume of a solvent having a boiling point of more than 100° C. and a surface tension of 30 to 40 mN/m, or not less than 0.3% in volume of a solvent having a boiling point of more than 100° C. and a surface tension of not more than 30 mN/m, preferably 0.8 to 10.0% in volume and more preferably 0.8 to 2.0% in volume of a solvent provided with a surface tension of 30 to 40 mN/m, together with inorganic fine particles and a hydrophilic binder. Further, it is characterized by containing 0.3 to 10.0% in volume and furthermore preferably 0.5 to 1.0% in volume of solvent provided with a surface tension of less than 30 mN/m and preferably a surface tension of 15 to 30 mN/m.

Solvents provided with a boiling point of more than 100° C. and a surface tension of not more than 40 mN/N include, for example, alcohols such as isopentylalcohol, 1,2-pentanediol, 1,2-hexanediol, dipropylene glycol, dipropylene glycol monoethylether, diethylene glycol monomethylether, diethylene glycol monobutylether, triethylene glycol monomethylether and triethylene glycol monobutylether; dimethylformamide and ethyl lactate. Specifically preferable solvents are 1,2-pentanediol and 1,2-hexanediol with respect to cracking resistance.

This invention is characterized by containing not less than 1.2 g/m² of a solvent provided with a surface tension of 30 to 40 mN/m or containing not less than 0.4 g/m² of a solvent provided with a surface tension of less than 30 mN/m. Further, in this invention, the addition amount of the above solvent provided with a surface tension of 30 to 40 mN/m is preferably not less than 0.8% based on a volume concentration against a coating solution and also preferably added is not less than 0.3% of a solvent provided with a surface tension of less than 30 mN/m. In the addition range defined by this invention, high glossiness and depression effect for bronzing can be obtained. Further, to obtain this effect, the boiling point of this solvent is necessary to be higher than that of water, with respect to a solvent provided with the above surface tension should remain during the drying process as well as after drying of a recoding sheet.

Herein, the above-described surface tension is one measured at 20° C. In the examples of this invention, it represents a mean value of 3 times measurement by use of CBVP Surface Tension Meter A-3 Type (produced by Kyowa Science Co., Ltd.).

In a recording sheet of this invention, the viscosity of an ink absorptive layer coating solution is 10 to 300 mPa·s, and it is preferable to form an ink absorptive layer by drying after the viscosity of said ink absorptive layer coating solution, having been coated on a support, has been increased to not less than 40 times, more preferably 40 to 400 times and furthermore preferably 100 to 350 times, of said viscosity at 40° C.

In this invention, a specific means to increase the viscosity of said ink absorptive layer coating solution after being coated on a support to not less than 40 times of said viscosity at 40° C. is not particularly limited, however, it can be achieved by providing a viscosity increasing property by temperature change (gelation by cooling) or ionized radiation irradiation after coating. For example, applied by suitable selection can be a method in which a large viscosity increasing effect at low temperature of a coating solution comprising silica as inorganic fine particles, polyvinyl alcohol as a hydrophilic binder and as boric acid as a cross-linking agent is utilized as described in JP-A Nos. 10-119423 and 2000-218927; a method in which a coating solution provided with a low temperature viscosity increasing effect by employing low temperature viscosity increasing fine particles constituted of a core portion comprising a copolymer containing a meth(acrylic) type monomer and a shell portion comprising N-isopropylacrylamide is utilized as described in JP-A No. 7-331224; in addition to this, photosensitive resins, described in JP-A Nos. 62-283339, 1-198615, 60-252341, 56-67309 and 60-129742, as a cross-linking and viscosity increasing means by ionized radiation.

An ink absorptive layer of this invention contains inorganic fine particles and a hydrophilic binder in addition to the above-described solvent, and constitutes voids.

Inorganic fine particles utilizable in this invention include, for example, white inorganic pigments such as light calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthesized amorphous silica, colloidal silica, alumina, colloidal alumina, pseudoboehmite, aluminum hydroxide, litopon, zeolite and magnesium hydroxide. The inorganic pigments described above may be utilized as primary particles as they are, or in a state of forming secondary condensed particles.

In this invention, to obtain a high quality print with an inkjet recording sheet, silica type particles or alumina type particles provided with a low diffractive index and an average particle size of approximately not more than 0.1 μm as inorganic particles are preferable with respect to availability at a relatively low cost, as well as alumina, pseudoboehmite, colloidal silica and fumed fumed silica are preferable, and in particular, fumed silica an average particle size of not more than 100 nm is specifically preferable.

The fumed silica may be one the surface of which is modified by aluminum. The aluminum content of gas phase method silica, the surface of which is modified by aluminum, is preferably 0.05 to 5%.

The average particle size of inorganic fine particles described above is preferably not more than 100 nm with respect to glossiness and color density. The under limit of the particle size is not specifically limited, however, in general preferably not more than 10 nm with respect to manufacturing.

The average particle size of inorganic fine particles described above can be determined by observing the cross-section or surface of a porous ink absorptive layer through an electronmicroscope to obtain particle diameters of arbitrary 100 particles, followed by calculating the simple average (number average). Herein, each particle diameter is represented by a diameter of a supposed circle having an area equivalent to the projection area of the particle.

The above described inorganic fine particles may present as primary particles as they are or as secondary or higher dimensionally aggregated particles in a porous layer, and the above-described particle size refers to that of independent particles in an ink absorptive layer when being observed through an electronmicroscope.

In the case that the above-described inorganic fine particles are aggregated particles of a secondary or higher dimension, the average primary particle size is smaller than the particle size observed in a porous layer and the primary particle diameter of inorganic fine particles is preferably not more than 30 μm and more preferably 4 to 20 nm.

The content of the above described inorganic fine particles in a water-based coating solution is 5 to 40 weight % and specifically preferably 7 to 30 weight %. The above-described inorganic fine particles need to form an ink absorptive layer provided with sufficient ink absorbability and minimum layer cracks, and are preferably contained so as to make a coating amount of 5 to 50 g/m² and specifically preferably of 10 to 30 g/m².

A hydrophilic binder contained in an ink absorptive layer is not specifically limited, however, utilized can be conventionally well known hydrophilic binders such as gelatine, polyvinyl alcohol, polyethylene oxide, polyacrylamide and polyvinyl alcohol, and specifically preferably polyvinyl alcohol with respect to a relatively small moisture absorbability of a binder, minimum curl of a recording sheet and a high binding capability for inorganic fine particles, as well as excellent cracking resistance and layer adhesion with a small amount addition.

Polyvinyl alcohols preferably utilized in this invention include modified polyvinyl alcohols such as those provided with a cationic modified end group or anionic modified polyvinyl alcohol provided with an anionic group, in addition to ordinary polyvinyl alcohol prepared by hydrolysis of polyvinyl acetate.

Polyvinyl alcohol prepared by hydrolysis of polyvinyl acetate is provided with a polymerization degree of preferably not less than 300 and specifically preferably 1,000-5,000, and a saponification degree of preferably 70-100% and specifically preferably 80-99.8%.

Cationic modified polyvinyl alcohol includes, for example, polyvinyl alcohol provided with a primary—tertiary amino group or a quaternary amino group in a main or side chain of the above described polyvinyl alcohol, and these are prepared by hydrolysis of a copolymer of an ethylenic unsaturated monomer having a cationic group and vinyl acetate.

Ethylenic unsaturated monomers having a cationic group include, for example, trimethyl-(2-acrylamido-2,2-dimethylethyl)ammonium chloride, trimethyl-(3-acrylamido-3,3-dimethylpropyl)ammonium chloride, N-vinylimidazole, N-methylvinylimidazole, N-(3-dimethylaminopropyl)methacrylamide, hydroxyethyl trimethylammonium chloride and trimethyl-(3-mehtacrylamidopropyl)ammonium chloride.

The content of a monomer containing a cationic modified group in cationic modified polyvinyl alcohol is 0.1-10.0 mol % and preferably 0.2-5.0 mol %.

Anionic modified polyvinyl alcohol includes, for example, polyvinyl alcohol provided with an anionic group described in JP-A No. 1-206088, a copolymer of vinyl alcohol and a vinyl compound having a water-soluble group described in JP-A Nos. 61-237681 and 63-307979, and modified polyvinyl alcohol having a water soluble group described in JP-A No. 7-286265.

Further, nonionic modified polyvinyl alcohol includes, for example, polyvinyl alcohol derivatives in which a polyalkylene oxide group is added to a part of polyvinyl alcohol described in JP-A No. 7-9758, and block copolymers of a vinyl compound having a hydrophobic group and polyvinyl alcohol described in JP-A No. 8-25795.

Polyvinyl alcohol can be utilized in combination of two or more types of such as different polymerization degrees and modification types. In particular, when polyvinyl alcohol having a polymerization degree of not less than 2,000 is utilized, it is preferable to add polyvinyl alcohol having a polymerization degree of not less than 2,000 after addition of 0.05 to 10 weight % and preferably 0.1 to 5.0 weight % based on inorganic fine particles in advance, because significant viscosity increase is avoided.

The ratio of inorganic fine particles against a hydrophilic binder in an ink absorptive layer is preferably 2 to 20 based on a weight ratio. When the weight ratio is not less then 2 times, a porous layer provided with a sufficient void ratio can be obtained to assure a sufficient void volume and not to induce the situation of clogging the void due to swelling of a hydrophilic binder at the time of inkjet recording, which is a factor to maintain a high ink absorption rate. While, when the ratio is not more than 20 times, there barely causes cracking even in the case of coating a thick ink absorptive layer. A specifically preferable ratio of inorganic fine particles against a hydrophilic binder is 2.5 to 12 times and most preferably 3 to 10 times.

In the above porous ink absorptive layer, utilized can be various types of additives other than inorganic fine particles and a hydrophilic binder, and among them, a cationic polymer, a cross-linking agent and a polyvalent metal compound play an important role with respect to improvement of ink absorbability and spreading resistance with respect to dye ink.

Examples of cationic polymers include such as polyethyleneimine, polyallylamine, polyvinylamine, a dicyandiamido polyalkylenepolyamine condensed compound, a polyalkylenepolydicyandiamido ammonium salt condensed compound, a dicyandimidoformarine condensed compound, an epichlorohydrine-dialkylamine addition polymerization compound, a diallyldimethylammonium chloride polymer, a diallyldimethylammonium chloride. SO² copolymer, polyvinylimidazole, a vinylpyrrolidone-vinylimidazole copolymer, polyvinyl pyridine, chitosan, cationized starch, a vinylbenzyl trimethylammonium chloride polymer, a (2-methacroyl oxyethyl)trimethylammonium chloride polymer and a dimethylaminoethyl methacrylate polymer.

Further, cationic polymers described in Kagaku Kogyo Jiho, Aug. 15 and 25 (1998) and polymer dye adhesives described in “Introduction of Polymer Medicines” published by Sanyo Chemical Industry Co., Ltd. are listed as examples.

On the other hand, polyvalent metal compounds (except ziruconium oxide and aluminum oxide) include metal compounds of such as aluminum, calcium, magnesium, zinc, iron, strontium, barium, nickel, copper, scandium, gallium, indium, titanium, zirconium, tin and lead. Further, polyvalent metal compounds may be a polyvalent metal salts. Among them, preferable are compounds comprised of magnesium, aluminum, zirconium, calcium and zinc because of being colorless.

In this invention, specifically preferably utilized cationic fixing agent are compounds represented by following general formula (1), polyamine or derivatives thereof, or polyvalent metal salts described below.

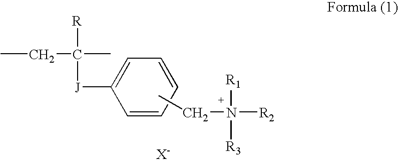

In above general formula (1), R represents a hydrogen atom or an alkyl group. R₁, R₂ and R₃ each represent an alkyl group or a benzyl group. J represents a simple bonding hand or a divalent organic group. X represents an anionic group. In general formula (1) described above, an alkyl groups represented by R is preferably a methyl group. Alkyl groups represented by R₁, R₂ and R₃ are preferably a methyl group, an ethyl group or a benzyl group. A divalent organic group represented by J is preferably —CON(R′)—. R′ represents a hydrogen atom or an alkyl group.

An anionic group represented by X includes, for example, a halogen ion, an acetic acid ion, a methyl sulfate ion, and a p-toluenesulfonate.

A preferable cationic polymer may be a homopolymer comprising a repeating unit represented by general formula (1) or a copolymer with another copolymerizable monomer. A copolymerizable repeating unit includes a cationic monomer other than above general formula (1) and monomers provided with no cationic group.

Monomers provided with a cationic group include, for example, the following repeating units.

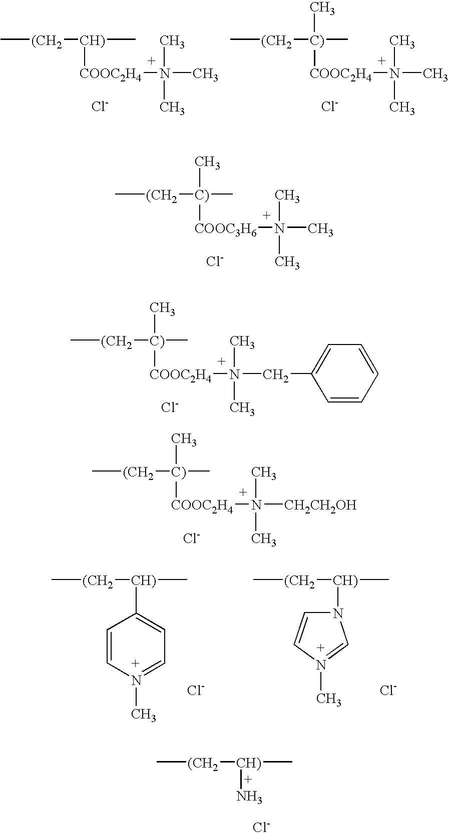

Copolymerizable repeating units provided with no cationic group include, for example, ethylene, styrene, butadiene, methyl methacrylate, ethyl methacrylate, propyl methacrylate, butyl methacrylate, octyl methacrylate, methyl acrylate, ethyl acrylate, propyl acrylate, butyl acrylate, octyl acrylate, hydroxylethyl methacrylate, acrylamide, vinyl acetate, vinylmethylether, vinyl chloride, 4-vinyl pyridine, N-vinyl pyrrolidone, N-vinyl imidazole and acrylonitrile.

In the case of cationic polymer utilized in this invention being provided with a repeating unit represented by aforesaid general formula (1), the content of said repeating unit is preferably not less than 20 mol % and specifically preferably 40 to 100 mol %.

Specific examples of a repeating unit represented by general formula (1) according to this invention are shown below, however, this invention is not limited thereto.

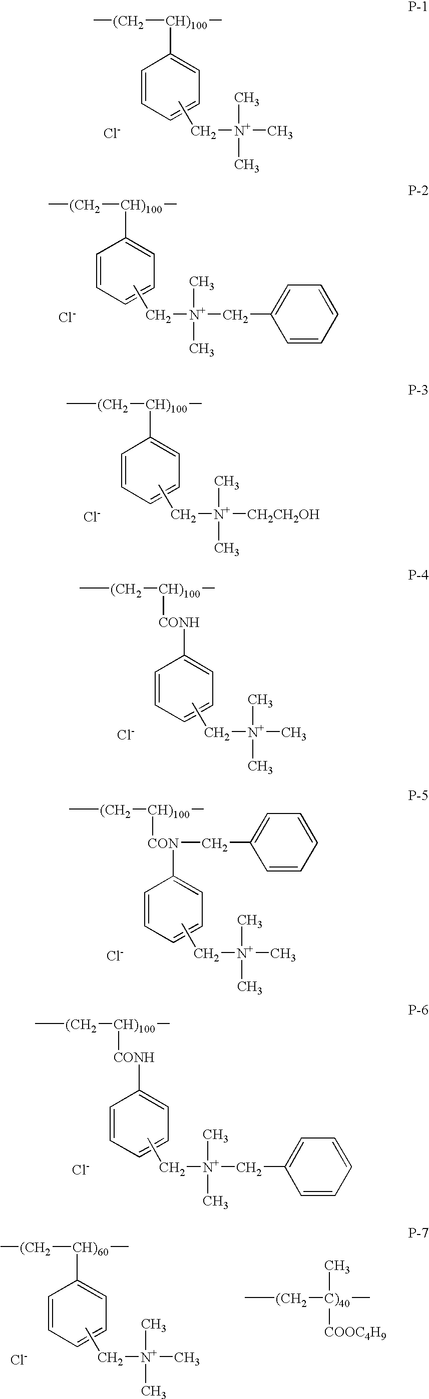

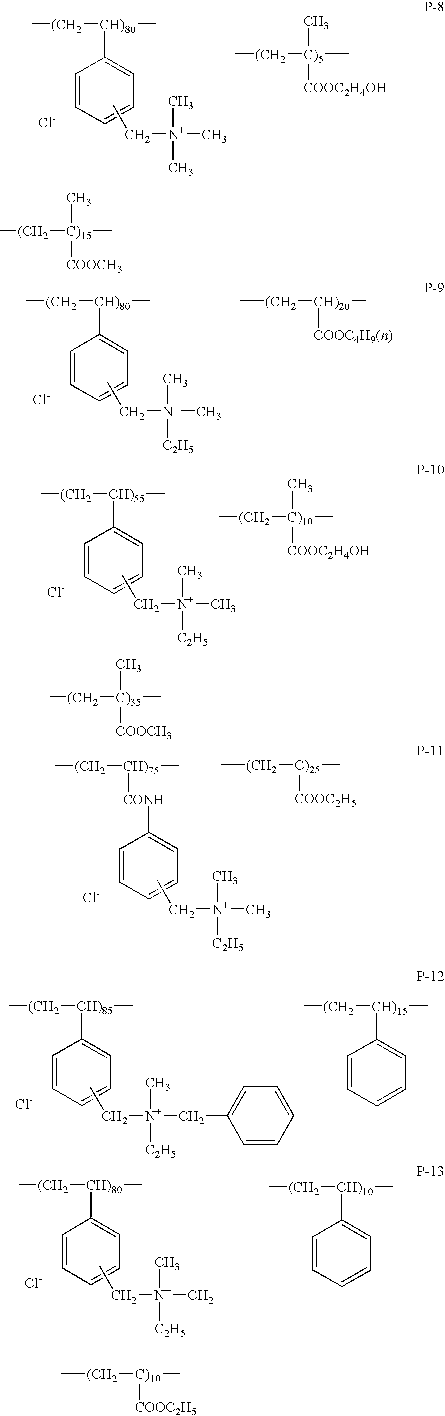

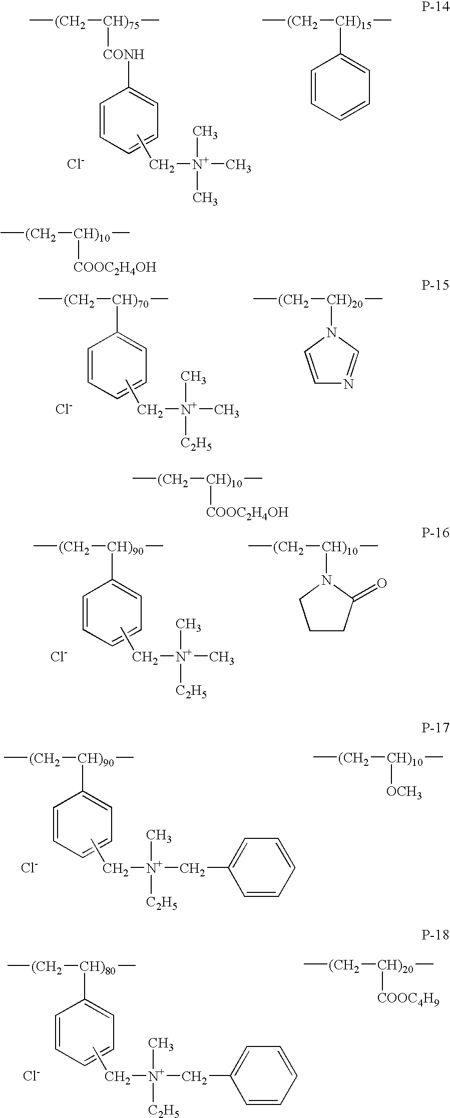

The weight average molecular weight of the above-described cationic polymer is generally 3,000 to 200,000 and preferably 5,000 to 100,000. The weight average molecular weight is expressed by polyethylene glycol conversion value obtained by means of gel permeation chromatography.

The using amount of a cationic polymer according to this invention is generally 0.1 to 10.0 g and preferably 0.2 to 5.0 g, per 1 m² of a recording sheet.

Next, polyamines according to this invention will be explained.

Polyamines referred in this invention are polyallylamines represented by aforesaid general formula (2), polydiallylamines represented by general formula (3) or general formula (4), polydiallylamine derivatives represented by general formula (5) or general formula (6) or polymers thereof.

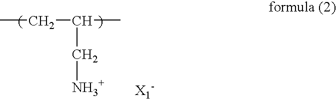

In general formula (2), X₁ represents a residual group of inorganic acids or organic acids.

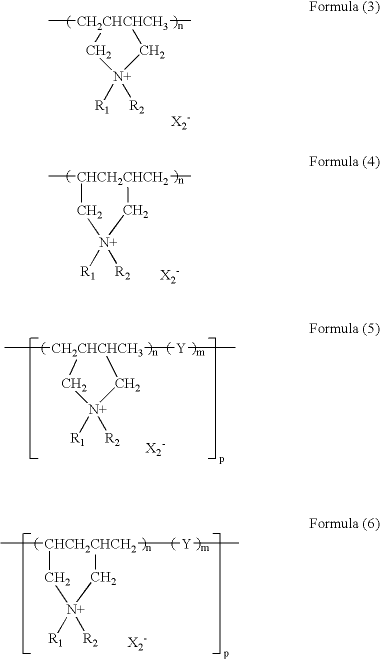

In general formulas (3), (4), (5) and (6), R₁ and R₂ each represent a hydrogen atom, a methyl group, an ethyl group or a hydroxyethyl group, X₂ represents an inorganic acid residual group or an organic acid residual group, Y represents a divalent bonding group and n, m, and p each represent a polymerization degree.

In general formulas (3) and (4), n represents an integer of 5 to 10,000. Further, in general formulas (5) and (6), n/m=9/1 to 2/8 and p=5 to 10,000.

Specific examples of polyallylamine derivatives represented by above general formula (5) or (6) include those containing a SO₂ group as a repeating unit which are represented by the general formula described in JP-A No. 60-83882; copolymers with acrylamide which are described at p. 2 of JP-A No. 1-9776; and those available on the market as a PAS series from Nitto Boseki Co., Ltd.

Preferable examples among these polyallylamines include polydimethyldiallyl ammoniums represented by general formulas (7) and (8).

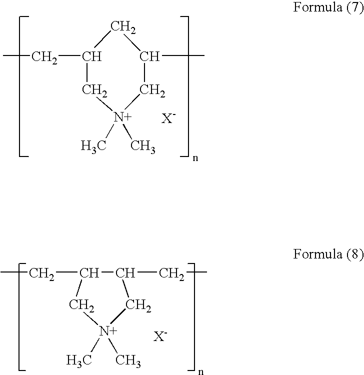

In above general formulas (7) and (8), n represents a polymerization degree. The polymerization degree is preferably not more than 1,000 and more preferably not more than 800. When the polymerization degree is over 1,000, viscosity is increased resulting in difficult handling. X is an atom or an atomic group to be an monovalent anion, preferably a halogen and most preferably a chlorine atom.

As the aforesaid polydimethyldiallyl ammoniums, a compound provided with a structure represented by above general formula (7) or a compound provided with a structure represented by above general formula (8) may be utilized as one type alone or in combination of the both types. In either case, those having different polymerization degrees may be utilized by mixing. Further, the aforesaid polydimethyldiallyl ammoniums may be either those suitably synthesized or available on the market.

Polyallylamines according to this invention (including salts and modified compounds thereof) are incorporated to improve spreading resistance, glossiness and printing densities, during image storage. Further, polyallylamines interact with a liquid ink comprising an anionic dye as a colorant to stabilize a colorant and can specifically more sufficiently improve water resistance and spreading resistance.

The weight average molecular weight of polyallylamines is preferably 3,000 to 30,000 and specifically preferably 5,000 to 20,000. When the weight average molecular weight is in the above range, it is possible to more sufficiently improve water resistance and spreading resistance.

The aforesaid salts of polyallylamines include inorganic salts such as hydrochlorate and sulfate, and organic salts such as acetate, toluensulfonate and methanesulfonate.

The aforesaid polyallylamine modified compounds are comounds of polyallylamine being added with 2 to 50 mol % of such as acrylonitrile, chloromethylstyrene, TEMPO and epoxyhexane, preferably adducts of 5 to 10 mol % of acrylonitrile and chrolomethylstyrene, and specifically preferably adducts of polyallylamine with 5 to 10 mol % of acrylonitrile, with respect to exhibiting an ozone fading restraining effect.

The content of polyallylamines is preferably 1 to 5 weight parts and more preferably 1.25 to 3.75 weight parts against 100 weight parts of inorganic fine particles. By setting the content of polyallylamines in the above range, effects of this invention can be efficiently exhibited.

Further, polyvalent metal compounds are preferably polyvalent inorganic polymer provided with a ziruconium atom or an aluminum atom, among them more preferably poly(aluminum chloride) compounds, poly(aluminum silicate sulfate) compound or zirconium activated inorganic polymers and furthermore preferably poly(aluminum chloride) compounds and poly(aluminum sulfate silicate) compounds.

Poly(aluminum chloride) compounds are represented by following general formulas (9), (10) and (11), and are poly(aluminum chloride) stably containing multi-nuclear condensed ion (polymeric), which is basic as well as provided with a higher positive charge, such as [Al₆(OH)₁₅]³⁺, [Al₈(OH)₂₀]⁴⁺, as an effective component.
[Al₂(OH)ₙCl₆₋ₙ]ₘ General formula (9)
[Al(OH)₃]ₙAlCl₃ General formula (10)
Alₙ(OH)ₘCl₍₃ₙ₋ₘ₎ General formula (11)

Poly(aluminum chloride) compounds available on the market include, for example, poly(aluminum hydroxide) (Paho) manufactured by Asada Chemicals Co., Ltd., poly(aluminum chloride) manufactured by Taki Chemicals Co., Ltd. and Purachem WT manufactured by Riken Green Co., Ltd., and in addition to these, those of a variety of grades, which are on the market for the purpose of water processing agents from other manufacturers, can be available.

Products of a poly(aluminum silicate sulfate) compound on the market include PASS manufactured by Nippon Light Metal Co., Ltd.

Products of a zirconium oxychloride type inorganic polymer on the market include Zirucozole ZC-2 manufactured by Daiichi Rare Element Chemical Industrial Co., Ltd. and compounds described in Japanese Patent No. 2944143 can be also utilized.

The above-described compounds including a zirconium atom or an aluminum atom may be added into a coating solution to form an ink absorptive layer, which is coated and dried, or may be added by an over-coating method after an ink absorptive layer has been once coated and dried.

In the case of compounds containing a zirconium atom or an aluminum atom described above being added into a coating solution to form an ink absorptive layer, they can be added by being homogeneously dissolved in water, an organic solvent or a mixed solvent thereof, or by being dispersing into minute particles by such as a wet type grinding method and an emulsifying method by use of a sand mill. When an ink absorptive layer is constituted of a plural number of layers, it may be added in one layer, in two or more layers or in the all layers.

While, in the case of addition by an over-coating method after once forming a porous ink absorptive layer, it is preferable to be added by being dissolved in a homogeneous solution.

Compounds containing a zirconium atom or an aluminum atom are utilized generally in a range of 0.01 to 5.0 g and specifically preferably in a range of 0.1 to 1.0 g, per 1 m² of an inkjet recording sheet.

The above-described compounds may be utilized in combination of two or more types, and in this case, utilized can be either at least two types of either compounds containing a zirconium atom or compounds containing an aluminum atom, or a compound containing a zirconium atom and a compound containing an aluminum atom in combination.

An inkjet recording sheet of this invention is preferably added with a hardener for a water-soluble binder which forms a porous ink absorptive layer.

Hardeners utilizable in this invention are not specifically limited provided they cause a curing reaction with a water soluble binder, however, preferably boric acid and salts thereof. In addition, those commonly known can be utilized other than these, and they are generally compounds provided with a group reactive with a water-soluble binder or compounds to accelerate a reaction between different groups of a water-soluble binder each other, which are utilized by suitable selection corresponding to a type of a water-soluble binder. Specific examples of the hardener include, for example, epoxy type hardeners (such as diglycidyl ethylether, ehtyleneglycol diglycidylether, 1,4-butanediol diglycidylether, 1,6-diglycidylcyclohexane, N,N-diglycidyl-4-glycidyloxyaniline, sorbitol polyglycidylether and glycelol polyglycidylether), aldehyde type hardeners (such as formaldehyde and glyoxal), active halogen type hardeners (such as 2,4-dichloro-4-hydroxy-1,3,5-s-triazine), active vinyl type hardeners (such as 1,3,5-trisacryloyl-hexahydro-s-triazine and bisvinylsulfonyl methylether) and aluminum alum.

Boric acids and salts thereof are oxyacids and salts thereof having a boron atom as the center atom, and specifically include orthoboric acid, diboric acid, methaboric acid, tetraboric acid, heptaboric acid and octaboric acid and salts tereof.

Boric acids and salts thereof having a boron atom as a hardener may be utilized as an aqueous solution of alone, or as a mixture of two or more types. Specifically preferable is a mixed aqueous solution of boric acid and borax. An aqueous solution of boric acid and borax enables to prepare a concentrated coating solution, because a concentrated aqueous solution can be formed by mixing boric acid and borax although each of them can be added only as a relatively diluted aqueous solution. Further, there is an advantage of relatively easy control of the pH of the addition aqueous solution. The total using amount of the above hardener is 1 to 600 mg per 1 g of the above water-soluble binder.

In a porous ink absorptive layer according to this invention, added can be various types of additives other than those described above. For example, incorporated can be commonly known various types of additives such as organic latex micro-particles of polystyrene, polyacrylic acid esters, polymethacrylic acid esters, polyacrylamides, polyethylene, polypropylne, polyvinyl chloride, polyvinilidene chloride, copolymers thereof, urea resin or melamine resin; various types of cationic or nonionic surfactants; UV absorbents described in JP-A Nos. 57-74193, 57-87988 and 62-261476; anti-fading agents described in JP-A Nos. 57-74192, 57-87989, 60-72785, 61-146591, 1-95091 and 3-13376; fluorescent whitening agents described in JP-A Nos. 59-42993, 59-52689, 62-280069, 61-242871 and 4-219266; pH controlling agents such as sulfuric acid, phosphoric acid, citric acid, sodium hydroxide, potassium hydroxide and potassium carbonate; defoaming agents, antiseptic agents, viscosity increasing agents, anti-static agents and matting agents.

A support utilized in this invention can be those well known as for conventional inkjet recording sheets. And it may be either a water absorptive support or a water non-absorptive support, however, preferably a water non-absorptive support.

Absorptive supports utilizable in this invention include, for example, sheet comprising ordinary paper, cloth and wood, however, paper is most preferable because the base material itself has excellent water absorbability and is superior with respect to cost. As a paper support, utilized can be those comprising wood pulp as a primary raw material such as chemical pulp such as LBKP and NBKP, machine pulp such as GP, CGP, RMP, TMP, CTMP, CMP and PGW, and such as used paper pulp such as DIP. Further, appropriately various fiber form substances such as synthetic pulp, synthetic fiber and inorganic fiber can be suitably utilized as a raw material.

In the above support, appropriately added can be various types of additives which are conventionally well known such as a sizing agent, a pigment, a paper strength increasing agent, a fixing agent, a fluorescent whitening agent, a wet paper strength increasing agent and a cationizing agent.

A paper support can be manufactured by mixing a fiber form substance such as wood pulp with various types of additives and by use of various types of paper making machines such as a long net paper making machine, a circular net paper making machine and a twin wire paper making machine. Further, a size press treatment with such as starch or alcohol, various coating treatments or a calendar treatment is appropriately performed during or after a paper making stage.

As a support for inkjet recording sheet of this invention, a water non-absorptive support is specifically preferable. A water non-absorptive support preferably utilized in this invention includes a transparent support or an opaque support. A transparent support includes films comprising a material such as polyester type resin, diacetate type resin, triacetate type resin, acryl type resin, polycarbonate type resin, polyvinyl chloride type resin, polyimide type resin, cellophane and celluloid, among them, preferable are those provided with a property resistant against radiation heat when being utilized for OHP, and specifically preferable is polyethylene terephthalate. The thickness of such transparent support is preferably 50 to 200 μm.

While, as an opaque support, preferable are, for example, resin coated paper (so-called RC paper) in which at least on the one side of a base paper is provided with a polyolefin resin coat layer added with such as a white pigment and so-called white PET comprising polyethylene terephthalate added with a white pigment such as barium sulfate.

To increase adhesion strength between the aforesaid various types of support and an ink absorptive layer, the support is preferably subjected to such as a corona discharge treatment or a sub-coat treatment in advance to being coated with an ink absorptive layer. Further, an inkjet recording sheet of this invention is not necessarily colorless but may be a colored one.

In an inkjet recording sheet of this invention, a paper support comprising a raw paper support, the both surfaces of which are laminated with polyethylene, is specifically preferably utilized with respect to obtaining a recoded image having near photographic image quality as well as a high quality image at low cost. In the following, such a polyethylene laminated paper support will be explained.

Raw paper utilized for a paper support is primarily comprised of wood pulp, and made into paper by appropriately incorporating synthetic pulp such as polypropylene or synthetic fiber such as nylon and polyester in addition to wood pulp. As wood pulp utilized can be any of LBKP, LBSP, NBKP, NBSP, LDP, NDP, LUKP and NUKP, however, it is preferable to utilize more LBKP, NBSP, LBSP, NDP and LDP which are rich in a short fiber component. Herein, a ratio of LBSP and/or LDP is preferably 10 to 70 weight %.

As pulp described above, chemical pulp containing minimum impurities (such as sulfate pulp and sulfite pulp) is preferably utilized and pulp, whiteness of which is improved by a bleach treatment, is also useful.

In raw paper, suitably added can be a sizing agent such as a higher fatty acid and an alkylketene dimmer; whitening agents such as calcium carbonate, talc and titanium oxide; paper strength increasing agents such as starch, polyacrylamide and polyvinyl alcohol; fluorescent whitening agents; moisture retaining agents such as polyethylene glycol; dispersants; and softening agents such as quaternary ammonium.

The drainage of pulp utilized in paper making is preferably 200 to 500 ml based on the definition of CSF, and a fiber length after beating is preferably 30 to 70% as the sum of a weight % of a 24 mesh residue and a weight % of a 42 mesh residue based on the definition of JIS-P-8207. Herein, a weight % of a 4 mesh residue is preferably not more than 20 weight %.

A basis weight of paper is preferably 30 to 250 g and specifically preferably 50 to 200 g. A thickness of paper is preferably 40 to 250 μm.

Paper may be subjected to a calendar treatment during or after the paper making to be provided with a high smoothness. A density of paper is generally 0.7 to 1.2 g/m² (JIS-P-8118). Further, a stiffness of raw paper is preferably 20 to 200 g based on the conditions defined in JIS-P-8143.

A surface sizing agent may be coated on the surface of raw paper, and surface sizing agents, similar to those can be added in the aforesaid raw paper, can be utilized.

A pH of raw paper is preferably 5 to 9 when being measured according to a hot water extraction method defined in JIS-P-8113.

Polyethylene coated on the front and back surfaces of raw paper is primarily law density polyethylene (LDPE) and/or high density polyethylene (HDPE), however, others such as LLDPE and polypropylene can be also partly utilized.

A polyethylene layer of an ink absorptive layer side is preferably one opacity and whiteness of which having been improved by addition of titanium oxide of a rutile or anatase type therein, as commonly applied in photographic print paper. A content of titanium oxide is generally 3 to 20 weight % and preferably 4 to 13 weight % based on polyethylene.

Polyethylene laminated paper can be utilized as glossy paper, and also utilized in this invention can be paper provided with a matt surface or a silk surface, similar to those prepared in ordinary photographic print paper, by a so-called embossing treatment when polyethylene is fusing extruded to be coated on the raw paper surface.

The water content of paper in the above polyethylene laminated paper is preferably maintained at 3 to 10 weight %.

In an inkjet recording sheet of this invention, added can be various types of additives other than those described above. For example, incorporated can be commonly known various types of additives such as organic latex micro-particles of polystyrene, polyacrylic acid esters, polymethacrylic acid esters, polyacrylamides, polyethylene, polypropylene, polyvinyl chloride, polyvinilidene chloride, copolymers thereof, or melamine resin; various types of cationic or nonionic surfactants; UV absorbents described in JP-A Nos. 57-74193, 57-87988 and 62-261476; anti-fading agents described in JP-A Nos. 57-74192, 57-87989, 60-72785, 61-146591, 1-95091 and 3-13376; fluorescent whitening agents described in JP-A Nos. 59-42993, 59-52689, 62-280069, 61-242871 and 4-219266; pH controlling agents such as sulfuric acid, phosphoric acid, citric acid, sodium hydroxide, potassium hydroxide and potassium carbonate; defoaming agents, antiseptic agents, viscosity increasing agents, anti-static agents and matting agents.

Next, a manufacturing method of an inkjet recording sheet of this invention will be explained.

An inkjet recording sheet of this invention can be manufactured by coating each constituent layer including an ink absorptive layer on a support, each independently or simultaneously by means of a suitably selected commonly known coating method, followed by drying. As a coating method, preferably utilized are, for example, a roll coating method, a rod-bar coating method, an air-knife coating method, a spray coating method, a curtain coating method, as well as a slide bead coating method described in U.S. Pat. Nos. 2,761,419 and 2,761,791, and an extrusion coating method.

A recording sheet of this invention is suitably utilized as a recording sheet for water-based pigment ink or water-based dye ink which is colorant containing ink.

Water-based dye ink refers to ink employing a water-soluble dye as a colorant and comprising water or a mixture of water and an organic solvent, provided with a high miscibility with water, as an ink solvent. As a dye, typically utilized are acid dyes, direct dyes or basic dyes conventionally well known, such as azo type dyes, xanten type dyes, phthalocyanine type dyes, quinone type dyes and anthraquinone type dyes, in which sulfo group or a carboxy group has been introduced to improve water solubility.

On the other hand, as pigments utilized in pigment ink, utilized can be various types of inorganic or organic pigments conventionally well known in inkjet application. Examples of an inorganic pigment include such as carbon black, titanium oxide and iron oxide. While, organic pigments include various types of azo type pigments, phthalocyanine type pigments, anthraquinone type pigments, quinacridone type pigments, indigo type pigments or lake pigments which are prepared by reacting a water-soluble dye and a polyvalent metal ion.

These pigment particles are preferably utilized in combination with various types of dispersants such as a hydrophilic binder and a surfactant or a dispersion stabilizer. Pigment particles are preferably utilized by being dispersed with these dispersant and dispersion stabilizer to have an average particle size of approximately 70 to 150 nm.

The concentration of the aforesaid dyes and pigments as a colorant in ink depends on types of dyes or pigments, using method of ink (whether deep and light inks are utilized or not), in addition to types of a recording sheet, however, is generally 0.2 to 10.0 weight %.

Various types of solvents are utilized in colorant containing ink, and water or an organic solvent having a high compatibility with water, alone or by being mixing with water, can be utilized as such solvents. Specifically listed are alcohol type solvents such as ethanol, 2-propanol, ethyleneglycol, propyleneglycol, glycerin, 1,2-hexanediol, 1,6-hexanediol, diethyleneglycol monomethylether and tetraethyleneglycol monomethylether; amides such as 2-pyrrolidinone, N-metylpyrrolidone and N,N-dimethylacetoamide; amines such as triethanol amine, N-ethyl morpholine and triethylenetetramine; sulforane, dimethylsulfoxide, urea, acetonitrile and acetone, which may be utilized alone or in combination.

Further, in the aforesaid colorant containing ink, various types of surfactants can be utilized for the purpose of increasing permeability of an ink solvent and other purposes. As such surfactants, preferably utilized are anionic or nonionic surfactants. Among them, acethyleneglycol type surfactants are specifically preferable.

An inkjet head which is utilized in an inkjet recording method employing an inkjet recording sheet of this invention may be either of an on-demand mode or a continuous mode. Further, an ink ejection mode includes such as an electro-mechanical conversion mode (such as a single cavity type, a double cavity type, a vendor type, a piston type, a share mode type and a shared-wall type), an electro-thermal conversion mode (such as a thermal inkjet type and a bubble jet (R) type) and an electrostatic suction mode (such as an electric field control type and a slit jet type), and any mode may be employed.

### EXAMPLES

In the following, this invention will be specifically explained referring to examples, however, this invention is not limited thereto.

Preparation of Recording Sheet [Preparation of Recording Sheet 1-1]

(Preparation of Ink Absorptive Layer Coating Solution)

After 10 kg of fumed silica (product name: Aerosil 300, manufactured by Nippon Aerosil Co., Ltd., an average primary particle size of 7 nm) was suction dispersed in a solution comprising 35 L of pure water added with 435 ml of ethanol at room temperature by use of Jet Stream Inductor Mixer manufactured by Mitamura Riken Kogyo Co., Ltd., the total volume was made up to 43.5 L with pure water, resulting in preparation of dispersion Al (pH of 2.8, containing 1 weight % of ethanol).

Next, 69 ml of an aqueous solution in which 2.6 g of boric acid and 1.8 g of borax were dissolved and 40 ml of a 28% aqueous solution of a cationic dye fixing agent (exemplary compound P-1) were added in 400 ml of dispersion Al. The resulting solution was preliminarily dispersed by Dissolver and followed by being homogenized by use of a sand mill homogenizer under a condition of a circumferential speed of 9 m/sec for 30 minutes. The total volume of this dispersion was made up to 510 ml to prepare nearly transparent silica fine particle dispersion (P-1). Obtained silica fine particle dispersion (P-1) was filtered through a filter of TCP-10 type manufactured by Advantex Toyo Co., Ltd.

Above-prepared silica fine particle dispersion (P-1) of 480 ml was added with 180 ml of a 8% aqueous solution of polyvinyl alcohol (product name: PVA 235, manufactured by Kuraray Corp.) followed by addition of 3 ml of a 50% aqueous solution of a surfactant (saponin), while being stirred at 40° C., and the total volume was made up to 800 ml with addition of pure water, resulting in preparation of a translucent ink absorptive layer coating solution.

(Formation of Ink Absorptive Layer)

The ink absorptive layer coating solution prepared above was coated on a polyethylene coat paper, comprising raw paper having a basis weight of 170 g/m² the both surfaces of which were coated with polyethylene (polyethylene of the ink absorptive layer side contained 8% of anatase type titanium oxide, the ink absorptive layer side was provided with 0.05 g/m² of a gelatin under-coat layer, and the opposite side surface to the ink absorptive layer was provided with 0.2 g/m² of a back layer containing a latex polymer having a Tg of approximately 80° C.), by use of a bar coater at a wet layer thickness of 150 μm. After coating, it was dried at 15° C. for 20 seconds followed by being dried by a hot wind of 65° C., resulting in preparation of recording sheet 1.

[Preparation of Recording Sheets 2 to 14]

Recording sheets 2 to 14 were prepared in a similar manner to preparation of above described recording sheet 1, except that each solvent described in Table 1 was added at each addition amount (a volume % in a coating solution) described in table 1 in the ink absorptive layer coating solution.

[Preparation of Recording Sheets 15 to 17]

Recording sheets 15 to 17 were prepared in a similar manner to preparation of above described recording sheet 4, except that an aqueous solution, comprising the following cationic fixing agents being diluted with water so as to make a solid content of 2.5%, was over-coated by use of a bar coater followed by being dried with a hot wind of 65° C.

Recording sheet 15: polyallylamine hydrochlorate, PAA-HCl-03, manufactured by Nitto Boseki Co., Ltd.

Recording sheet 16: poly(aluminum chloride) compound, PAC 250A, manufactured by Taki Chemical Industry Co., Ltd.

Recording sheet 17: zirconium oxychloride type inorganic polymer, Zircozole ZC-2, manufactured by Daiichi Rare Element Chemical Industry Co., Ltd.

[Preparation of Recording Sheet 18]

Recording sheet 18 was prepared in a similar manner to preparation of recording sheet 1, except that an amount, to adjust the pH of silica fine particle dispersion to 4.8, of a phosphoric acid buffer solution was added instead of boric acid-borax aqueous solution utilized in preparation of silica fine particle dispersion (P-1), and the drying was performed by use of an oven (with no wind) of 65° C. after cooling at 15° C. for 20 seconds.

[Preparation of Recording Sheets 19 and 20]

Recording sheets 19 and 20 were prepared in a similar manner to preparation of recording sheet 18, except that each solvent described in Table 1 was added at each addition amount (a volume % in a coating solution) described in table 1 in the ink absorptive layer coating solution.

[Preparation of Recording Sheets 21 to 23]

Recording sheets 21 to 23 were prepared in a similar manner to preparation of recording sheets 15 to 17, except that recording sheet 4 utilized for over coating was changed to recording sheet 1.

With respect to each recording sheet prepared in the above manner, observation of the ink absorptive layer surface through an electronmicroscope proved that an average particle size of silica as inorganic fine particles was in a range of 36 to 40 nm.

The details of each solvent utilized in preparation of recording sheets 2 to 17, 19 and 20 are as follows.
Sol-1: 1,2-hexanediol (surface tension: 26.3 mN/m, boiling point: 118° C.)
Sol-2: triethyleneglycol monomethylether (surface tension: 36.3 mN/m, boiling point: 160° C.)
Sol-3: 1,5-pentanediol (surface tension: 43.2 mN/m, boiling point: 242° C.)
Sol-4: 2-propanol (surface tension: 21.7 mN/m, boiling point: 82° C.)
Sol-5: 1,2-penetanediol (surface tension: 28.4 mN/m, boiling point: 211° C.)<
   Measurement and Evaluation of Each Characteristic
   [Viscosity Measurement of Ink Absorptive Layer Coating Solution]

With respect to each ink absorptive layer coating solution utilized in preparation of each recording sheet described above, the viscosities at 40° C. and 15° C. were measured by use of a vibration viscosity meter (FVM-80A, manufactured by Yamaichi Denki Co., Ltd.).

[Measurement of Glossiness]

With respect to the ink absorptive layer side surface of each recording sheet, 60 degree glossiness was measured by use of a variable degree gloss meter (VGS-1001DP) manufactured by Nippon Denshoku Industry Co., Ltd.

[Evaluation of Cracking Resistance]

With respect to 10×10 cm² of the ink absorptive layer side surface of each recording sheet, the number of generated cracks of not less than 5 μm in size was counted by use of a loupe to evaluate cracking resistance according to the following criteria. Herein, the allowable limit level with respect to coated layer quality is B, and out of the allowable range are C and D.
A: No cracks of not less than 5 μm in size are generated at all.
B: The number of generated cracks of not less than 5 μm in size is 1 to 3.
C: The number of generated cracks of not less than 5 μm in size is 4 to 9.
D: The number of generated cracks of not less than 5 μm in size is at least 10.
   [Evaluation of Bronzing]

Each mono color solid image of M, C and K and each solid image of R, G and B were printed on each recording sheet prepared above by use of Inkjet Printer PMG800 manufactured by Seiko Epson Corp., and the state of printed images was visually observed after the printed sheets had been stored at 23° C. and a relative humidity of 80% for 1 week, followed by evaluation based on the criteria described below.
A: Bronzing is barely observed.
B: Bronzing is observed partly, which is not a problem in practical use.
C: Bronzing was observed in solid images of the all RGB colors, which is a problem in practical use.
D: Bronzing of the all colors is observed, which is a problem in practical use.
   [Evaluation of Spreading Resistance]

Each line of magenta (M), cyan (C) and black (K) was printed at 0.3 mm width on each recording sheet by use of Inkjet Printer PMG800 manufactured by Seiko Epson Corp., and the printed sheets were stored in a clear file for 30 days after having been kept standing for 1 hour. Each line width after storage was measured with a microdensitometer to determine a widened ratio of the line width (line width after storage/line width before storage), and spreading resistance was evaluated according to the following criteria.
A: The line widened ratio is less than 1.1.
B: The line widened ratio is not less than 1.1 and less than 1.3.
C: The line widened ratio is not less than 1.3 and less than 1.5.
D: The line widened ratio is at least 1.5.
   Herein, when a line width widened ratio is not less than 1.5, it was considered to be a problematic level in practical print application.

Each result obtained above is shown in table 1.

TABLE 1

| | Ink absorptive layer | | | | | | | | | | | |
|---|---|---|---|---|---|---|---|---|---|---|---|---|
| | Solvent | | | Viscosity of coating | | | Each evaluation result | | | | | |
| Recording | | Addition | | solution (mPa · s) | | | | | | Spreading | | |
| sheet | | amount | Content | V1 | V2 | | | Cracking | Bronzing | resistance | | |
| No. | Type | (%) | (g/m²) | (40° C.) | (15° C.) | V2/V1 | Glossiness | resistance | resistance | M | K | Remarks |
| 1 | — | — | — | 75 | 24000 | 320 | 33.2 | A | C | B | B | Comp. |
| 2 | Sol-1 | 0.2% | 0.30 | 69 | 22500 | 326 | 35.8 | A | C | B | B | Comp. |
| 3 | Sol-1 | 0.3% | 0.45 | 68 | 21000 | 309 | 44.0 | A | A | B | B | Inv. |
| 4 | Sol-1 | 0.6% | 0.90 | 65 | 19800 | 305 | 46.3 | A | A | B | B | Inv. |
| 5 | Sol-1 | 1.0% | 1.50 | 62 | 17600 | 284 | 46.9 | A | A | B | B | Inv. |
| 6 | Sol-1 | 1.3% | 2.00 | 62 | 17000 | 274 | 47.0 | A | B | B | B | Inv. |
| 7 | Sol-2 | 0.6% | 0.90 | 64 | 5800 | 91 | 35.0 | A | A | B | B | Comp. |
| 8 | Sol-2 | 0.8% | 1.20 | 60 | 5000 | 83 | 42.1 | B | A | B | B | Inv. |
| 9 | Sol-2 | 1.3% | 2.00 | 53 | 2700 | 51 | 44.0 | B | A | B | B | Inv. |
| 10 | Sol-2 | 1.5% | 2.25 | 52 | 2200 | 42 | 44.6 | B | B | C | C | Inv. |
| 11 | Sol-3 | 1.0% | 1.50 | 63 | 22000 | 349 | 33.3 | A | A | B | B | Comp. |
| 12 | Sol-3 | 2.0% | 3.00 | 56 | 18000 | 321 | 33.4 | A | A | B | B | Comp. |
| 13 | Sol-4 | 1.0% | 1.50 | 65 | 23000 | 354 | 33.4 | A | C | B | B | Comp. |
| 14 | Sol-4 | 2.0% | 3.00 | 62 | 21800 | 352 | 33.4 | A | C | B | B | Comp. |
| 15 | Sol-1 | 0.6% | 0.90 | 65 | 19800 | 305 | 47.1 | A | A | A | A | Inv. |
| 16 | Sol-1 | 0.6% | 0.90 | 65 | 19800 | 305 | 46.9 | A | A | A | A | Inv. |
| 17 | Sol-1 | 0.6% | 0.90 | 65 | 19800 | 305 | 46.9 | A | A | A | A | Inv. |
| 18 | — | — | — | 70 | 900 | 13 | 36.7 | C | C | B | B | Comp. |
| 19 | Sol-1 | 0.6% | 0.90 | 64 | 850 | 13 | 44.9 | B | A | B | B | Inv. |
| 20 | Sol-5 | 0.6% | 0.90 | 65 | 850 | 13 | 45.8 | B | A | B | B | Inv. |
| 21 | — | — | — | 75 | 24000 | 320 | 33.2 | A | D | A | A | Comp. |
| 22 | — | — | — | 75 | 24000 | 320 | 33.2 | A | D | A | A | Comp. |
| 23 | — | — | — | 75 | 24000 | 320 | 33.2 | A | D | A | A | Comp. |

Comp.: Comparison
Inv.: Invention

It is clear from the results of table 1 that recording sheets of this invention, utilizing an ink absorptive layer coating solution containing not less than 0.3 volume % of a solvent provided with a boiling point of more than 100° C. and a surface tension of not more than 40 mN/m, provide images of high quality exhibiting excellent cracking resistance and high glossiness as well as excellent bronzing resistance and spreading resistance. Further, recording sheets 3, 4, 6, 7, 12, 13 and 14 enable high speed drying by means of hot wind drying, which is provided with a preferable manufacturing characteristics with respect to productivity.

The present invention can provide a porous type inkjet recording sheet, which has high ink absorbability and can provide a high quality image, restrained bronzing and high glossiness, as well as a manufacturing method thereof.

It is to be noted that various changes and modifications will be apparent to those skilled in the art. Therefore, unless such changes and modifications depart from the scope of the present invention, they should be construed as being included therein.

1. A porous type inkjet recording sheet comprising a substrate provided thereon an ink absorptive layer which is formed by coating a coating solution on the substrate and then drying,
wherein the coating solution comprises inorganic fine particles, a hydrophilic binder and a solvent of not less than 0.8% in volume, the solvent having a boiling point of more than 100° C. and a surface tension of 30 to 40 nm/m.

2. A porous type inkjet recording sheet comprising a substrate provided thereon an ink absorptive layer which is formed by coating a coating solution on the substrate and then drying,
wherein the coating solution comprises inorganic fine particles, a hydrophilic binder and a solvent of not less than 0.3% in volume, the solvent having a boiling point of more than 100° C. and a surface tension of less than 30 mN/m.

3. A porous type inkjet recording sheet comprising a substrate provided thereon an ink absorptive layer,
wherein the ink absorptive layer comprises inorganic fine particles, a hydrophilic binder and a solvent of not less than 1.2 g/m², the solvent having a boiling point of more than 100° C. and a surface tension of 30 to 40 mN/m.

4. A porous type inkjet recording sheet comprising a substrate provided thereon an ink absorptive layer,
wherein the ink absorptive layer comprises inorganic fine particles, a hydrophilic binder and a solvent of not less than 0.4 g/m2, the solvent having a boiling point of more than 100° C. and a surface tension of less than 30 mN/m.

5. The porous type inkjet recording sheet in claim 1 wherein the inorganic fine particles are fumed silica having an average particle size of not more than 100 nm.

6. The porous type inkjet recording sheet in claim 1,
wherein a viscosity at 40° C. of the coating solution is 10 to 300 mPa·s and the drying is carried out after a viscosity of the ink absorptive layer coated by the coating becomes not less than 40 times of the viscosity at 40° C. of the coating solution.

7. The porous type inkjet recording sheet in claim 1,
wherein the ink absorptive layer contains a cationic fixing agent.

8. A method of forming a porous type inkjet recording sheet comprising:
coating a coating solution on the substrate and then drying,
wherein the coating solution comprises inorganic fine particles, a hydrophilic binder and a solvent of not less than 0.8% in volume, the solvent having a boiling point of more than 100° C. and a surface tension of 30 to 40 mN/m.

9. A method of forming a porous type inkjet recording sheet comprising coating a coating solution on the substrate and then drying,
wherein the coating solution comprises inorganic fine particles, a hydrophilic binder and a solvent of not less than 0.3% in volume, the solvent having a boiling point of more than 100° C. and a surface tension of less than 30 mN/m.

10. The method of forming a porous type inkjet recording sheet of claim 8,
wherein the inorganic fine particles are fumed silica having an average particle size of not more than 100 nm.

11. The method of forming a porous type inkjet recording sheet of claim 8,
wherein a viscosity at 40° C. of the coating solution is 10 to 300 mPa-s and drying is carried out after a viscosity of the ink absorptive layer coated by the coating becomes not less than 40 times of the viscosity at 40° C. of the coating solution.

12. The method of forming a porous type inkjet recording sheet of claim 8,
wherein the ink absorptive layer coating solution contains a cationic fixing agent.
